(19) United States
(12) Patent Application Publication
(10) Pub. No.: US 2015/0248408 A1
(43) Pub. Date: Sep. 3, 2015

(54) METHOD AND APPARATUS PRESENTING FILTERED DATA IN COMBINATION WITH A REPLACEMENT DATA ITEM

(71) Applicants: Christian Rossing KRAFT, Espoo (CN); Jouni Tapio NEVALAINEN, Ii (FI)

(72) Inventors: Christian Rossing Kraft, Bangkok (TH); Jouni Tapio Nevalainen, Ii (FI)

(21) Appl. No.: 14/436,431

(22) PCT Filed: Oct. 19, 2012
(86) PCT No.: PCT/CN2012/083236

§ 371 Date: Apr. 16, 2015

(51) Int. Cl. G06F 17/30

(52) U.S. Cl. CPC G06F 17/30029; G06F 17/30867; G06F 17/30058; G06Q 50/01

(57) ABSTRACT

A method, apparatus and computer program product are provided to facilitate browsing activity and the resulting download of data. In the context of a method, filtered data is received in response to browsing activity. The filtered data includes information regarding a data item that has been removed from the filtered data. The method may also identify a replacement data item based upon a selection criteria. The replacement data item may be different than the data item that has been removed from the filtered data. For example, the replacement data item may include an image, a video, an audio recording or an advertisement. The method may also cause presentation of the filtered data in combination with a replacement data item and based at least partially upon the information regarding the data item that has been removed.

### TECHNOLOGICAL FIELD

A method, apparatus and computer program product are provided in accordance with an example embodiment in order to cause filtered data to be presented in combination with a replacement data item and, more particularly, to cause filtered data to be presented in combination with a replacement data item with the presentation being based at least partially upon information regarding a data item that has been removed from the filtered data.

### BACKGROUND

Users of a wide variety of computing devices commonly engage in web browsing, such as by browsing various web pages. Web browsing may be performed for any number of purposes including research, entertainment or the like. The web pages that are viewed as a result of the web browsing are generally downloaded from a server, such as a web server, to the computing device that the user is utilizing to conduct the web browsing. Depending upon the data included in the web page that is selected for viewing and the number of web pages that are selected to be viewed, a significant quantity of data may need to be downloaded to the computing device in order to permit the user to view the selected web pages.

Web pages include a wide variety of data. In this regard, web pages may include text as well as other types of data, such as images, videos, audio recordings, advertisements or the like. By way of example, FIG. 1 illustrates a web page generated by a weather application that has been downloaded to a mobile computing device. As shown, the web page includes images, such as the image of the sun peeking out from behind a cloud as well as the images representative of the weather forecast for Wednesday, Thursday, Friday, and Saturday. The web page of FIG. 1 also includes text, such as 6° 3°, Partly Cloudy, Humidity: 35%, Wind: --.

The images, videos, audio recordings, advertisements or other media content that are included in web pages may be substantially larger than the text of the web page in terms of the quantity of data that must be downloaded in order to view the web page. As a result, the downloading of the images, videos, audio recordings, advertisements or other media content of a web page may slow the downloading process and, accordingly, increase the power consumption required to support the downloading relative to the downloading of the text of a web page. Additionally, the increased amounts of data that must be downloaded in order to view a web page that includes images, videos, audio recordings, advertisements or other media content may also increase the cost associated with the downloading process since the cost may be based upon the quantity of data downloaded.

In order to reduce the quantity of data that must be downloaded in order to view a web page and to correspondingly increase the speed of the downloading process, reduce the power consumption required to support the downloading process and potentially reduce the costs associated with the downloading process, some users conduct text only browsing in which a user browses the text of web pages without consideration of any images, videos, audio recordings or other media content included within the web pages. Thus, the downloading of text-only web pages may proceed more quickly. However, as shown in FIG. 2 which depicts a text-only representation of a web page provided by a weather application, the resulting web page may be less informative, less intuitive, less interesting and may generally diminish the user experience relative to web pages that include images, videos, audio recordings or other media content.

### BRIEF SUMMARY

A method, apparatus and computer program product are provided in accordance with an example embodiment of the present invention in order to facilitate browsing activity and the resulting download of data, such as a portion of a web page. In this regard, the method, apparatus and computer program product of an example embodiment may receive filtered data in response to browsing activity with one or more data items having been removed from the filtered data. For example, the method, apparatus and computer program product of one embodiment may receive the text of a web page with the images, videos, audio recordings, advertisements or other media content having been removed from the web page prior to being downloaded. In order to improve the user experience, however, the method, apparatus and computer program product of an example embodiment may identify a replacement data item for a data item that has been removed from the filtered data and may then cause the presentation of not only the filtered data, but also the replacement data item. As such, a user of one embodiment of the method, apparatus and computer program product may enjoy the benefits associated with the downloading of a smaller quantity of data, while also being presented with a more interesting display in which the replacement data item supplements the filtered data that was downloaded.

In one embodiment, a method is provided that includes receiving filtered data in response to browsing activity. The filtered data includes information regarding a data item that has been removed from the filtered data. The method of this embodiment also identifies a replacement data item based upon a selection criteria. The replacement data item may be different than the data item that has been removed from the filtered data. In one embodiment, the replacement data item may include an image, a video, an audio recording or an advertisement. The method of this embodiment may also cause presentation of the filtered data in combination with a replacement data item and based at least partially upon the information regarding the data item that has been removed.

In order to identify the replacement data item, the method of one embodiment defines the selection criteria based upon the filtered data. In this embodiment, the selection criteria may be defined based upon at least one of metadata associated with the data item that has been removed, an attribute associated with the data item that has been removed, a title of the data item that has been removed, a description of the data item that has been removed, text proximate the data item that has been removed, a title of the filtered data or an address associated with the filtered data.

The method of one embodiment may identify the replacement data item by searching data items that are locally stored and selecting one of the data items that are stored locally to be the replacement data item based upon the selection criteria. In one embodiment, the method may identify the replacement data item by identifying a plurality of candidate replacement data items and selecting one of the candidate replacement data items to be the replacement data item based upon the selection criteria.

The information regarding a data item that has been removed from the filtered data may include information identifying a location of the data item that has been removed relative to the filtered data. In this embodiment, the method may cause the presentation of the filtered data by causing the replacement data item to be positioned relative to the filtered data in accordance with the location of the data item that has been removed.

The method of one embodiment may also include receiving, in response to the presentation of filtered data in combination with the replacement data item, user input requesting the data item that has been removed from the filtered data. The method of this embodiment may also receive the data item that has been removed from the filtered data in response to the user input and may cause the presentation to be modified to include the filtered data in combination with the data that had previously been removed. In regards to the user input that is received, the method of one embodiment may receive user input in association with the presentation of the replacement data item. In this embodiment, the method may also include causing a request for the data item that has been removed from the filtered data. Thereafter, the method may cause the presentation to be modified by replacing the replacement data item with the data item that had previously been removed.

In another embodiment, an apparatus is provided that includes at least one processor and at least one memory including computer program code with the at least one memory and the computer program code configured to, with the processor, cause the apparatus to at least receive filtered data in response to browsing activity. The filtered data includes information regarding a data item that has been removed from the filtered data. The at least one memory and the computer program code are also configured to, with the processor, cause the apparatus of this embodiment to identify a replacement data item based upon a selection criteria. The replacement data item may be different than the data item that has been removed from the filtered data. In one embodiment, the replacement data item may include an image, a video, an audio recording or an advertisement. The at least one memory and the computer program code are additionally configured to, with the processor, cause the apparatus of this embodiment to cause presentation of the filtered data in combination with a replacement data item and based at least partially upon the information regarding the data item that has been removed.

In order to identify the replacement data item, the at least one memory and the computer program code may be configured to, with the processor, cause the apparatus of one embodiment to define the selection criteria based upon the filtered data. In this embodiment, the selection criteria may be defined based upon at least one of metadata associated with the data item that has been removed, an attribute associated with the data item that has been removed, a title of the data item that has been removed, a description of the data item that has been removed, text proximate the data item that has been removed, a title of the filtered data or an address associated with the filtered data.

The at least one memory and the computer program code may be configured to, with the processor, cause the apparatus of one embodiment to identify the replacement data item by searching data items that are locally stored and selecting one of the data items that are stored locally to be the replacement data item based upon the selection criteria. In one embodiment, the at least one memory and the computer program code may be configured to, with the processor, cause the apparatus to identify the replacement data item by identifying a plurality of candidate replacement data items and selecting one of the candidate replacement data items to be the replacement data item based upon the selection criteria.

The information regarding a data item that has been removed from the filtered data may include information identifying a location of the data item that has been removed relative to the filtered data. In this embodiment, the at least one memory and the computer program code may be configured to, with the processor, cause the apparatus to cause the presentation of the filtered data by causing the replacement data item to be positioned relative to the filtered data in accordance with the location of the data item that has been removed.

The at least one memory and the computer program code may also be configured to, with the processor, cause the apparatus of one embodiment to receive, in response to the presentation of filtered data in combination with the replacement data item, user input requesting the data item that has been removed from the filtered data. The at least one memory and the computer program code may additionally be configured to, with the processor, cause the apparatus of this embodiment to receive the data item that has been removed from the filtered data in response to the user input and to cause the presentation to be modified to include the filtered data in combination with the data that had previously been removed. In regards to the user input that is received, the at least one memory and the computer program code may be configured to, with the processor, cause the apparatus of one embodiment to receive user input in association with the presentation of the replacement data item. In this embodiment, the at least one memory and the computer program code may also be configured to, with the processor, cause the apparatus to include causing a request for the data item that has been removed from the filtered data. Further, the at least one memory and the computer program code may be configured to, with the processor, cause the apparatus to thereafter cause the presentation to be modified by replacing the replacement data item with the data item that had previously been removed.

In a further embodiment, a computer program product is provided that includes at least one non-transitory computer-readable storage medium having computer-executable program code portions stored therein with the computer-executable program code portions including program code instructions for receiving filtered data in response to browsing activity. The filtered data includes information regarding a data item that has been removed from the filtered data. The computer-executable program code portions of this embodiment also include program code instructions for identifying a replacement data item based upon a selection criteria. The replacement data item may be different than the data item that has been removed from the filtered data. In one embodiment, the replacement data item may include an image, a video, an audio recording or an advertisement. The computer-executable program code portions of this embodiment additionally include program code instructions for causing presentation of the filtered data in combination with a replacement data item and based at least partially upon the information regarding the data item that has been removed.

In order to identify the replacement data item, the computer-executable program code portions of one embodiment may also include program code instructions for defining a selection criteria based upon the filtered data. In this embodiment, the selection criteria may be defined based upon at least one of metadata associated with the data item that has been removed, an attribute associated with the data item that has been removed, a title of the data item that has been removed, a description of the data item that has been removed, text proximate the data item that has been removed, a title of the filtered data or an address associated with the filtered data.

The program code instructions for identifying the replacement data item may include program code instructions for searching data items that are locally stored and selecting one of the data items that are stored locally to be the replacement data item based upon the selection criteria. In one embodiment, the program code instructions for identifying the replacement data item may include program code instructions for identifying a plurality of candidate replacement data items and selecting one of the candidate replacement data items to be the replacement data item based upon the selection criteria.

The information regarding a data item that has been removed from the filtered data may include information identifying a location of the data item that has been removed relative to the filtered data. In this embodiment, the program code instructions for causing the presentation of the filtered data include program code instructions for causing the replacement data item to be positioned relative to the filtered data in accordance with the location of the data item that has been removed.

The computer-executable program code portions of one embodiment may also include program code instructions for receiving, in response to the presentation of filtered data in combination with the replacement data item, user input requesting the data item that has been removed from the filtered data. The computer-executable program code portions of this embodiment may also include program code instructions for receiving the data item that has been removed from the filtered data in response to the user input and for causing the presentation to be modified to include the filtered data in combination with the data that had previously been removed. In regards to the user input that is received, the computer-executable program code portions of one embodiment may include program code instructions for receiving user input in association with the presentation of the replacement data item. In this embodiment, the computer-executable program code portions may also include program code instructions for causing a request for the data item that has been removed from the filtered data. The program code instructions for causing the presentation to be modified may include program code instructions for thereafter replacing the replacement data item with the data item that had previously been removed.

In yet another embodiment, an apparatus is provided that includes means for receiving filtered data in response to browsing activity. The filtered data includes information regarding a data item that has been removed from the filtered data. The apparatus of this embodiment also includes means for identifying a replacement data item based upon a selection criteria. The apparatus of this embodiment may also include means for causing presentation of the filtered data in combination with a replacement data item and based at least partially upon the information regarding the data item that has been removed.

### BRIEF DESCRIPTION OF THE SEVERAL VIEWS OF THE DRAWINGS

Having thus described certain embodiments of the invention in general terms, reference will now be made to the accompanying drawings, which are not necessarily drawn to scale, and wherein:

FIG. 1 is an illustration of a mobile computing device that is presenting a web page including both text and images;

FIG. 2 is an illustration of a mobile computing device that is presenting a web page that includes only text;

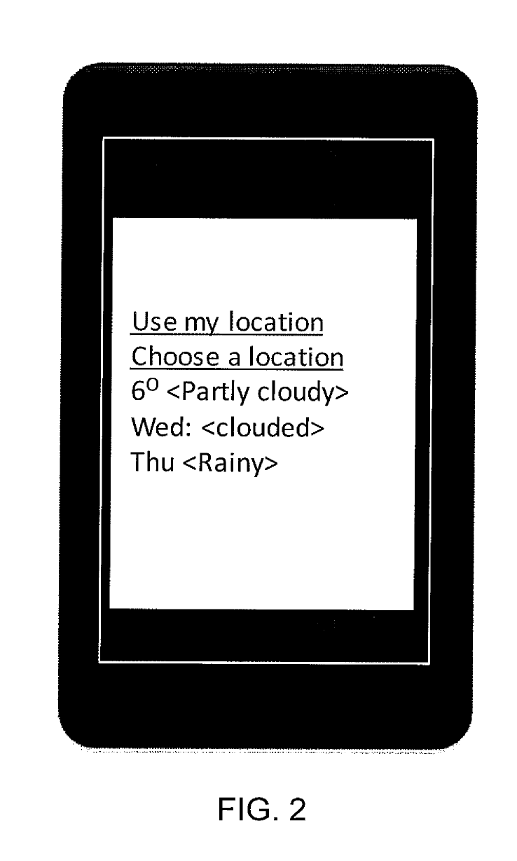

FIG. 3 is a schematic representation of a system that may support communications, such as browsing activity, between a server and a computing device;

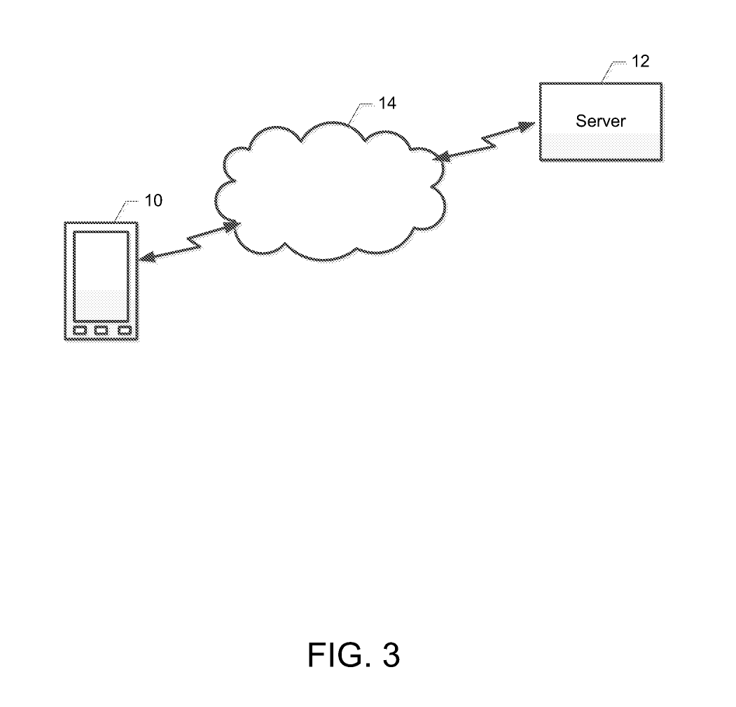

FIG. 4 is a block diagram of an apparatus that may be specifically configured in accordance with an example embodiment of the present invention;

FIG. 5 is a flow chart illustrating operations performed, such as by the apparatus of FIG. 4, in accordance with an example embodiment of the present invention;

FIG. 6 is an illustration of the text of a web page from which two images have been removed in accordance with an example embodiment of the present invention;

FIG. 7 is a flow chart illustrating the operations performed in order to identify a replacement data item in accordance with an example embodiment of the present invention;

FIG. 8 is an illustration of the web page of FIG. 6 following the addition of replacement data items for the images that had been removed in accordance with an example embodiment of the present invention; and

FIG. 9 is an illustration of the web page of FIGS. 6 and 8 following replacement of one of the replacement data items with the corresponding data item that had previously been removed in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

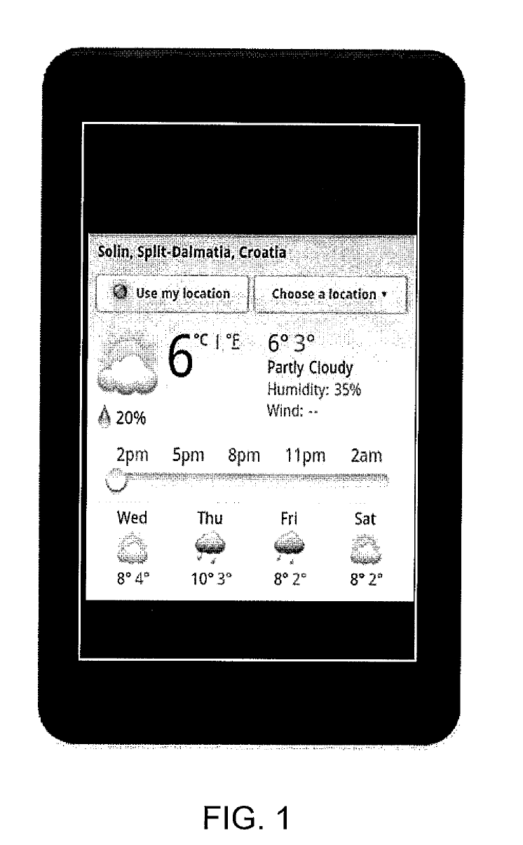

Referring now of FIG. 1, a system that supports communication, either wirelessly or via a wireline, between a computing device 10 and a server 12 is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

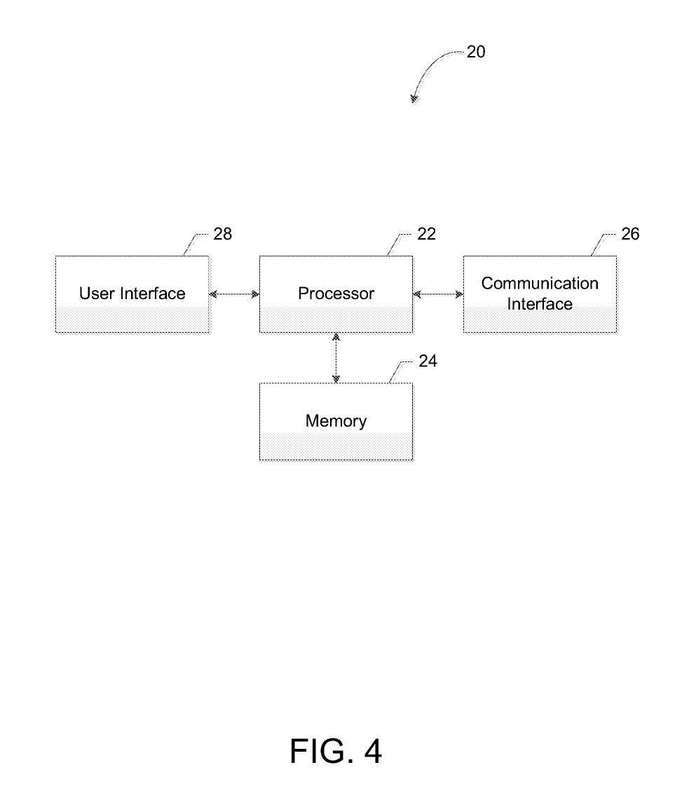

Regardless of the type of device that embodies the computing device 10, the computing device may include or be associated with an apparatus 20 as shown in FIG. 4. In this regard, the apparatus may include or otherwise be in communication with a processor 22, a memory device 24, a communication interface 26 and a user interface 28. It should be noted that while FIG. 4 illustrates one example of a configuration of an apparatus, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

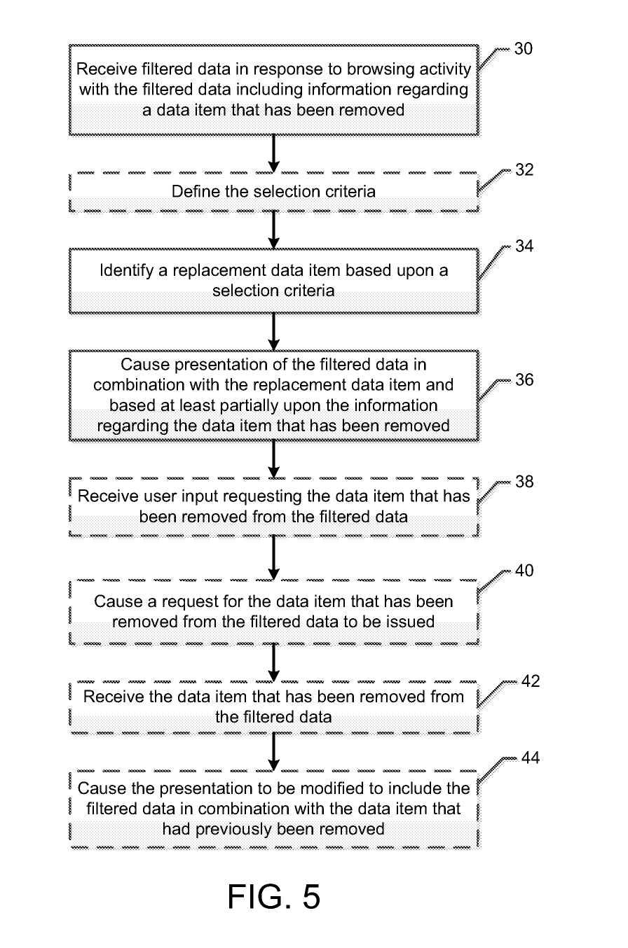

Referring now to FIG. 5, the operations that may be performed, such as by the apparatus 20 of FIG. 4, in accordance with an example embodiment of the present invention are illustrated. In this regard, a user of the computing device 10 may engage in browsing activity in order to identify information (described hereinafter by way of example, but not of limitation, as one or more web pages) that the user desires to view. The browsing activity may be conducted in various manners including the entry of search queries that may be provided to the server 12 which, in turn, may provide one or more links to web pages that are responsive to the query. The user may then select or actuate one of the links to view the corresponding web page. Alternatively, the browsing activity may be conducted by entering an address, such as a uniform resource locator (URL), that identifies a web page of interest.

Prior to downloading the data that comprises the web page to the computing device 10, the server 12 may identify one or more data items that are to be removed. The data items that are to be removed may be predefined, at least in terms of the type of the data items, and are typically the data items that are larger in size, as measured in bytes of data, and would therefore require additional time to be downloaded to the computing device. In one embodiment, for example, the data items that are to be removed include images, videos, audio recordings, advertisements or other media content. Once the data items have been identified and removed, the resulting filtered data that is the product of the user's browsing activity, such as the filtered data of a web page requested by the user, may be downloaded from the server to the computing device.

As shown in block 30 of FIG. 5, the apparatus 20 embodied by the computing device 10 may therefore be configured to receive the filtered data in response to the browsing activity. The apparatus embodied by the computing device therefore includes means, such as the processor 22, the communication interface 26 or the like, for receiving the filtered data in response to the browsing activity. In addition to the data that was not removed, such as the text of the web page requested by the user that was not removed prior to downloading, the filtered data may include information regarding a data item that has been removed. Various types of information regarding the data item that has been removed may be provided including information defining the position of the data item relative to other portions of the web page, e.g., relative to the text. Other types of information regarding the data item that has been removed may include information regarding the title of the data item that has been removed, attributes of the data item that has been removed, key words associated with the data item that has been removed, tags, e.g., hypertext markup language (HTML) image tags, associated with the data item that has been removed, metadata associated with the data item that has been removed, etc. Thus, although the data item that has been removed is not received by the computing device, at least not initially, the filtered data that is received by the computing device includes information regarding the data item that was removed.

The filtered data that is received may be of various types depending upon the types of data items that were removed prior to the downloading of the filtered data. In an embodiment in which the data items that were removed prior to the downloading of the filtered data include images, videos, audio recordings, advertisements or other media content that were included or embedded within a web page requested by the user, the filtered data may include the remainder of the web page and, in one embodiment, may include principally, if not entirely, text. By having removed one or more data items, such as the larger data items, from the filtered data prior to the downloading of the filtered data, the filtered data may be downloaded more quickly and efficiently relative to the downloading of the original web page that included not only the filtered data, but also the data items that were removed. By way of example in which the filtered data includes the text of a web page, the downloading of the text of a web page may proceed much more quickly and efficiently than the downloading of the original web page that not only includes the text, but also one or more images, videos or audio recordings. As such, the filtered data may be received more quickly, at less cost and may require less power consumption.

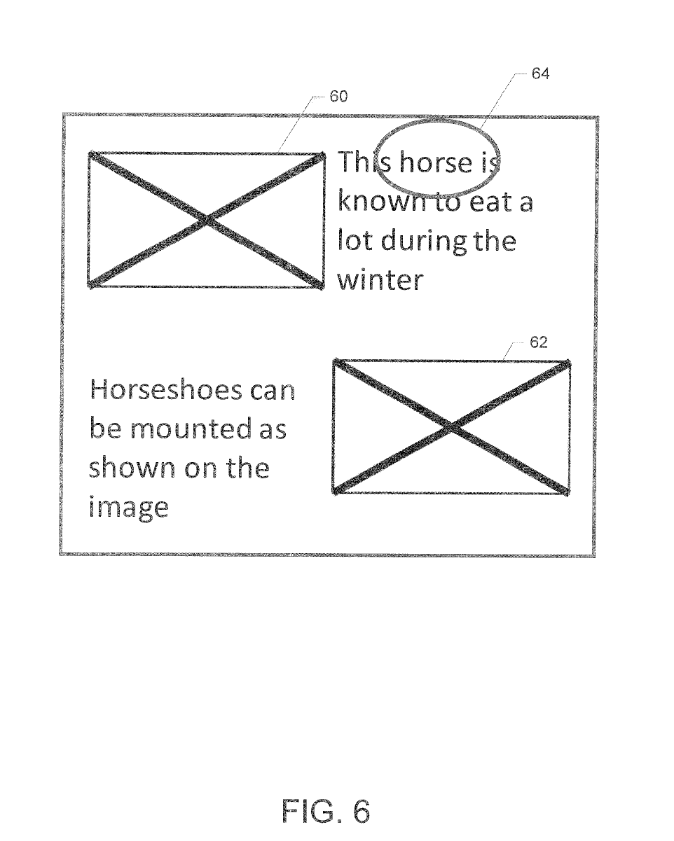

By way of example, FIG. 6 illustrates a web page that was requested following web browsing by the user. Prior to downloading of the web page, two images were removed as represented in FIG. 6 by rectangles 60, 62 that are crossed through but that are positioned at the locations at which the images were previously located within the original web page. Although the two images were removed, the filtered data that was downloaded includes the text of the web page as well as information regarding the images that were removed.

As shown in block 34 of FIG. 5, the apparatus 20 embodied by the computing device 10 may also be configured to identify a replacement data item based upon a selection criteria. Thus, the apparatus may include means, such as the processor 22 or the like, for identifying a replacement data item. In one embodiment, the selection criteria may be predefined. However, in other embodiments, the apparatus may be configured to define the selection criteria prior to identifying the replacement data item. See block 32 of FIG. 5. Thus, the apparatus may also include means, such as processor or the like, for defining the selection criteria. The apparatus, such as the processor, may define various types of selection criteria. In one embodiment, the selection criteria is based upon the filtered data and, more particularly, the information regarding a data item that has been removed from the filtered data. The filtered data, such as the information regarding the data item that has been removed from the filtered data, that is considered by the apparatus, such as the processor, in conjunction with the identification of a replacement data item may include any number of different types of information including metadata associated with the data item that has been removed, an attribute associated with the data item that has been removed, a title of the data item that has been removed, a description of the data item that has been removed, text proximate the data item that has been removed, a title of the filtered data, e.g., the title of the web page, and an address associated with the filtered data, e.g., a URL associated with the web page, or any combination thereof.

In regards to the web page of FIG. 6, the apparatus 20, such as the processor 22, may be configured to search the text proximate the image 60 that has been removed in order to identify a key word, such as “horse” 64, which is associated with the image that has been removed. The apparatus, such as the processor, may then utilize this key word, e.g., horse, as the selection criteria for a replacement data item for image 60. As another example, the apparatus, such as the processor, may be configured to identify an attribute associated with image 62 that has been removed from the web page of FIG. 6, such as the attribute “horse shoe” included within a tag, e.g., an HTML image tag, associated with the image. The apparatus, such as the processor, may then utilize this attribute, e.g., horse shoe, as the selection criteria for a replacement data item for image 62. Although the apparatus, such as the processor, of one embodiment may define the selection criteria in the same manner for each data item that has been removed, the foregoing examples demonstrate that the apparatus, such as the processor, of another embodiment may define the selection criteria in different manners for the different data items that have been removed from the filtered data.

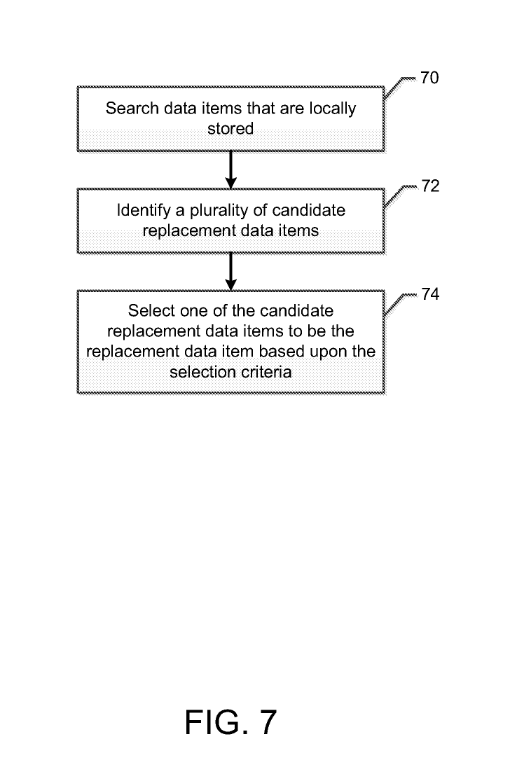

Following the definition of the selection criteria, such as by reference to the filtered data and, in one embodiment, by reference to the information regarding a data item that has been removed from the filtered data, the apparatus 20, such as the processor 22, may be configured to at identify the replacement data item, as shown generally in block 34 of FIG. 5 and, in more detail, in FIG. 7. The replacement data item may be of various types, such as images, videos, audio recordings, advertisements or other media content. As shown in block 70 of FIG. 7, for example, the apparatus may include means, such as the processor or the like, of one embodiment for searching data items that are stored by or otherwise associated with the computing device 10. In order to avoid having to download the replacement data item, the apparatus, such as a processor, of one embodiment may be configured to search data items that are locally stored. The data items that are searched may have been provided by various sources. For example, the data items that are searched may include images, videos or audio recordings captured by the computing device 10 or previously downloaded, such as in response to the prior downloading of another web page. Additionally or alternatively, the data items that are searched may include data items that were initially loaded upon and provided with the computing device or data items that have been received from others, such as an attachment to an electronic mail message or a multimedia messaging service (MMS) message or via a social website or application. In one embodiment, each of the data items that are searched includes or is associated with information relating to the data item, such as attributes of the data item, the title of the data item, a description of the data item, key words associated with the data item, metadata associated with the data item or the like.

In one embodiment, the apparatus 20, such as the processor 22, may be configured to select one of the data items that have been searched, such as from among the data items that are locally stored, to be the replacement data item based upon the selection criteria. In this regard, based upon the selection criteria that was previously defined, the apparatus, such as the processor, may identify each of the data items that are locally stored that match the selection criteria. For example, in an instance in which the selection criteria is a key word associated with the text proximate an image, such as “horse,” the apparatus, such as the processor, may search the data items that are locally stored in order to identify each data item that is associated with the key word “horse.” As another example, in instances in which the selection criteria is defined to be a tag associated with an image that relates to “horse shoes,” the apparatus, such as the processor, may search the data items that are stored locally in order to identify each data item that has a tag associated therewith that references “horse shoes.” As noted above, other types of selection criteria may be defined with the resulting analysis of the data items that are stored locally being conducted accordingly.

In some embodiments, the apparatus 20 may include means, such as the processor 22 or the like, for identifying a plurality of candidate replacement data items with each candidate replacement data item satisfying the selection criteria that has been defined. See block 72 of FIG. 7. In this embodiment, the apparatus may include means, such as the processor or the like, for selecting one of the candidate replacement data items to be the replacement data item based upon the selection criteria. See block 74. The apparatus, such as the processor, may be configured to select one of the candidate replacement data items in various manners. In one embodiment, the apparatus, such as the processor, may be configured to select the candidate replacement data item that most closely matches the selection criteria to be the replacement data item. In this regard, the apparatus, such as the processor, may be configured to determine the matching of a candidate replacement data item to the selection criteria in various manners. For example, in an instance in which the selection criteria includes multiple factors, e.g., key word of horse and tag of horse shoes, a candidate replacement data item may be considered to more closely match the data item that was removed in an instance in which the candidate replacement data item matches each of the multiple factors as opposed to matching only one or some subset of the multiple factors. As another example, a candidate replacement data item may be considered to more closely match the data item that was removed in an instance in which the candidate replacement data item is an exact match to the selection criteria relative to a candidate replacement data item that is similar to, but not the same as, the selection criteria. In an instance in which a plurality of candidate replacement data items are identified, the apparatus, such as the processor, may additionally or alternatively be configured to select a candidate replacement data item to be the replacement data item by identifying the candidate replacement data item that was stored, modified or accessed most recently.

Once the replacement data item has been identified, the apparatus 20 may be configured to cause the presentation of the filtered data in combination with the replacement data item. See block 36 of FIG. 5. Thus, the apparatus may include means, such as the processor 22, the user interface 28 or the like, for causing the presentation of the filtered data in combination with the replacement data item. In this regard, the presentation of the filtered data and the replacement data item is based at least partially upon the information regarding the data item that has been removed. For example, the information regarding the data item that has been removed may include information identifying the location of the data item that has been removed relative to the filtered data. As such, the apparatus, such as the processor, the user interface or the like, may cause the replacement data item to be positioned relative to the filtered data in accordance with the location of the data item that has been removed. In this regard, the replacement data item may be presented at the same relative location and at the same scale or size as the data item that has been removed.

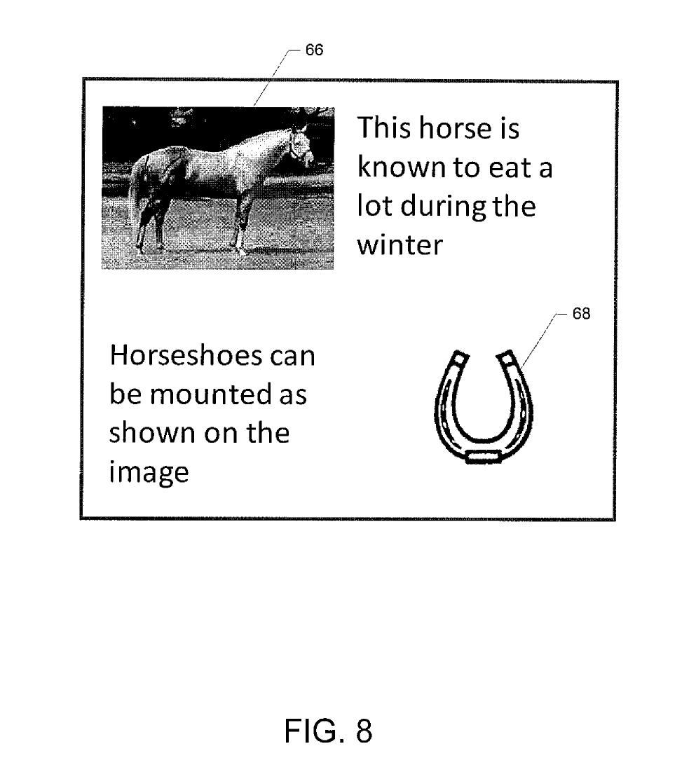

By way of example, FIG. 8 illustrates a web page that may be generated in response to an example embodiment of the present invention. In this embodiment, an image 66 of a horse was identified to be the replacement data item for image 60 that was removed from the filtered data prior to downloading of the filtered data to the computing device 10. The image 66 of the horse that is included in the presentation of the web page may be different than the image 60 of the horse that was removed from the web page prior to its downloading. However, the image 66 of the horse that is included in the presentation of the web page may have been stored locally and therefore did not need to be downloaded with the filtered data, thereby increasing the speed and efficiency with which the downloading occurred. Additionally, the image 66 of the horse may be presented at the same location and in the same scale as the image 60 of the horse that was removed from the filtered data prior to downloading since the image 66 of the horse is caused to be presented based upon the information regarding the data item that was removed including, for example, information regarding the relative position of the data item that was removed with respect to the filtered data. Similarly, an image 68 of a horse shoe may be presented as the replacement data item for data item 62 that was removed prior to the downloading. Again, the image 68 of the horse shoe may be a different image than the image that was removed prior to downloading, but the image of the horse shoe may have been identified from those images stored locally by the computing device so as not to require downloading.

As such, the method, apparatus and computer program product may cause a web page of the type shown in FIG. 8 to be presented in accordance with one embodiment of the present invention. In this regard, it is noted that the web page depicted in FIG. 6 is generally not presented, but is illustrated for purposes of explanation and is not intended to be a representation of an actual image that is presented upon the user interface 28. However, in an instance in which the apparatus 20, such as the processor 22, is unable to identify a replacement data item that satisfies the selection criteria associated with the data item that has been removed from the filtered data, the presentation of the filtered data may include an indication of the data item that has been removed, such as in the form of a crossed out box, e.g., boxes 60 and 62 of FIG. 6, in one embodiment.

As described above, the replacement data item may be related to and, in some respects, similar to the data items that were removed from the filtered data prior to downloading. However, the selection criteria may be defined in some embodiments in a manner such that the replacement data items are not related, at least in subject matter, to the data items that were removed prior to downloading. For example, the selection criteria may be defined to identify a replacement data item of the same type as the data item that was removed, e.g., an image, a video, an audio recording or the like, that was most recently or more frequently accessed by the user of the computing device 10. Alternatively, the selection criteria may be defined to identify a replacement data item of the same type as the data item that was removed with the replacement data item having being preselected by the user. As such, the replacement data items of this embodiment may be unrelated to the data items that were removed from the filtered data in terms of the underlying subject matter, but the replacement data items that are presented in combination with the filtered data by the method, apparatus and computer program product of this embodiment may still increase the user's interest in the resulting display by being data items that were frequently or recently accessed by the user. In one embodiment, the apparatus, such as the processor, is configured to initially attempt to identify a replacement data item that is related to the data item that has been removed and, in an instance in which a related replacement data item cannot be identified, may then identify a replacement data item of the type described above that is not related to the data that was removed, thereby defining the relative priority between the different types of replacement data items.

In one embodiment, a user of the computing device 10 may elect to download the data item that was previously removed from the filtered data after having been viewed the combination of a filtered data and a replacement data item. For example, a user viewing the web page of FIG. 8 may desire to see the image that has now been replaced by the image 68 of the horse shoe. As such, the apparatus 20 of this embodiment may include means, such as the processor 22, the user interface 28 or the like, for receiving user input requesting the data item that has been removed from the filtered data. See block 38 of FIG. 5. In one embodiment, the user input may be provided in association with the presentation of the replacement data item. For example, the user may interact with the user interface to position a cursor upon the portion of the image represented by the replacement data item, such as the image 68 of the horse shoe, and may then select that portion of the image. Alternatively, in instances in which the user interface includes a touch screen, a user may simply touch the portion of the display that includes the presentation of the replacement data item, such as the image 68 of the horse shoe, in order to request the data item that was previously removed from the filtered data.

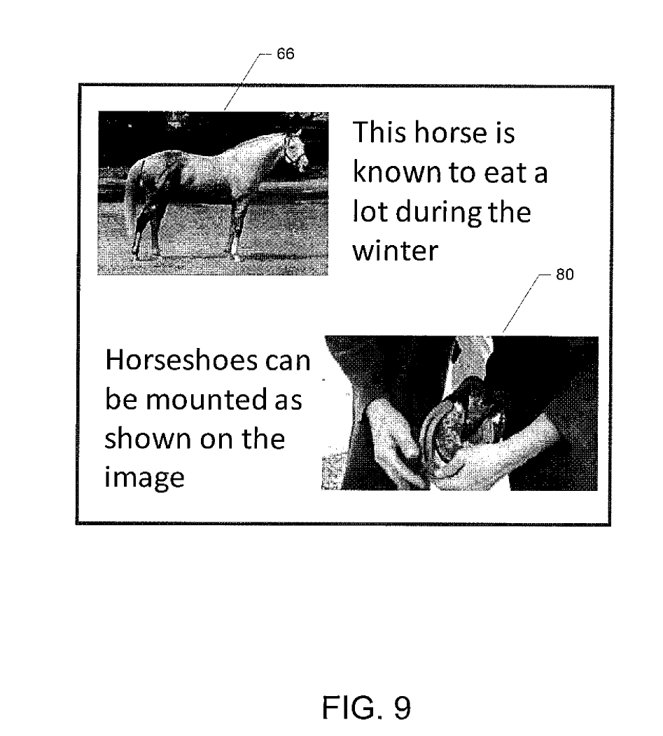

In this embodiment, the apparatus 20 may include means, such as the processor 22, the communication interface 26 or the like, for causing a request for the data item that has been removed from the filtered data to be issued, such as to the server 12. See block 40 of FIG. 5. The apparatus of this embodiment may also include means, such as the processor, the communication interface or the like, for receiving the data item that was previously removed from the filtered data. See block 42. The apparatus may also include means, such as the processor, the user interface 28 or the like, for causing the presentation to be modified to include the filtered data in combination with the data item that had previously been removed. See block 44 of FIG. 5. In this regard, the presentation may be modified by replacing the replacement data item with the data item that was previously removed. As shown in FIG. 9, for example, the image 68 of the horse shoe may be replaced by the original image 80 that was previously removed prior to the downloading of the filtered data, but that has now been provided by the server in response to the user request. Thus, in instances in which the user desires to see the original data items even at the expense occasioned by the downloading of increased amounts of data, the method, apparatus and computer program product of an example embodiment may permit the presentation to be accordingly modified so as to include the original data item.

A method, apparatus and computer program product are therefore provided in accordance with example embodiments of the present invention to facilitate browsing and the resulting download of data, such as web pages. In this regard, the method, apparatus and computer program product of an example embodiment may cause filtered data to be downloaded after one or more data items, such as images, videos, audio recordings, advertisements or other media content, have been removed therefrom in order to reduce the amount of data that is downloaded. In order to improve the user experience, however, the method, apparatus and computer program product of an example embodiment may supplement the presentation of the filtered data with one or more replacement data items, such as replacement data items that were stored locally and therefore need not be downloaded.

As described above, FIGS. 5 and 7 illustrate flowcharts of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

In some embodiments, certain ones of the operations above may be modified or further amplified as described below. Moreover, in some embodiments additional optional operations may also be included (some examples of which are shown in dashed lines in FIG. 5). It should be appreciated that each of the modifications, optional additions or amplifications below may be included with the operations above either alone or in combination with any others among the features described herein.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-30. (canceled)

31. A method comprising:
processing filtered data received in response to browsing activity, wherein the filtered data includes information regarding a data item that has been removed from the filtered data that is received;
identifying a replacement data item of a same data type as the data item removed based upon one or more selection criteria comprising one or more criteria based on the filtered data, the selection criteria also including at least one criterion for the replacement data item preselected by a user; and
causing presentation of the filtered data in combination with the replacement data item, wherein the presentation is based at least partially upon the information regarding the data item that has been removed, wherein the replacement data item comprises a data item previously received from a web-site or application other than a web-site or application causing presentation of the filtered data.

32. A method as claimed in claim 31, wherein the browsing activity is on the web-site or application causing presentation of the filtered data.

33. A method as claimed in claim 31, wherein the web-site or application other than the web-site or application causing presentation of the filtered data comprises an electronic mail messaging web-site or application and wherein the data item comprises an attachment to an electronic mail message.

34. A method as claimed in claim 31, wherein the web-site or application other than the web-site or application causing presentation of the filtered data comprises an electronic mail messaging web-site or application and wherein the replacement data item comprises an attachment to an electronic mail message.

35. A method as claimed in claim 31, wherein the web-site or application other than the web-site or application causing presentation of the filtered data comprises a multi-media messaging service web-site or application and a data item comprises an attachment to a multi-media messaging service message.

36. A method as claimed in claim 31, wherein the web-site or application other than the web-site or application causing presentation of the filtered data comprises a multi-media messaging service web-site or application and the replacement data item comprises an attachment to a multi-media messaging service message.

37. A method as claimed in claim 31, wherein the web-site or application other than the web-site or application causing presentation of the filtered data comprises a social network web-site or application and the data item comprises a data item provided by the social network web-site or application.

38. A method as claimed in claim 31, wherein the web-site or application other than the web-site or application causing presentation of the filtered data comprises a social network web-site or application and the replacement data item comprises a data item provided by the social network web-site or application.

39. A method according to claim 31, wherein the one or more selection criteria based on the filtered data are pre-defined by a user's selection.

40. A method according to claim 31, wherein the replacement data item comprises at least one of image data, video data, audio data, or advertisement data.

41. An apparatus comprising at least one processor and at least one memory including computer program code, the at least one memory and the computer program code configured to, with the processor, cause the apparatus to at least:
process filtered data received in response to browsing activity, wherein the filtered data includes information regarding a data item that has been removed from the filtered data that is received;
identify a replacement data item of a same data type as the data item removed based upon one or more selection criteria comprising one or more criteria based on the filtered data, the selection criteria also including at least one criterion for the replacement data item preselected by a user; and
cause presentation of the filtered data in combination with the replacement data item, wherein the presentation is based at least partially upon the information regarding the data item that has been removed, wherein the replacement data item comprises a data item previously received from a web-site or application other than a web-site or application causing presentation of the filtered data.

42. An apparatus as claimed in claim 41, wherein the browsing activity is on the web-site or application causing presentation of the filtered data.

43. An apparatus as claimed in claim 41, wherein the web-site or application other than the web-site or application causing presentation of the filtered data comprises one of:
an electronic mail messaging web-site or application and the data item comprises an attachment to an electronic mail message;
an electronic mail messaging web-site or application the replacement data item comprises an attachment to an electronic mail message;
a multi-media messaging service web-site or application and the data item comprises an attachment to a multi-media messaging service message;
a multi-media messaging service web-site or application and the replacement data item comprises an attachment to a multi-media messaging service message;
a social network web-site or application and the data item comprises a data item provided by the social network web-site or application; and
a social network web-site or application and the replacement data item comprises a data item provided by the social network web-site or application.

44. An apparatus as claimed in claim 41, wherein the one or more selection criteria based upon the filtered data are pre-defined by a user's selection.

45. An apparatus as claimed in claim 41, wherein a type of replacement data item comprises at least one of an image, a video, an audio recording or an advertisement.

46. A computer program product comprising at least one non-transitory computer-readable storage medium having computer-executable program code portions stored therein, the computer-executable program code portions comprising program code instructions for:
processing filtered data received in response to browsing activity, wherein the filtered data includes information regarding a data item that has been removed from the filtered data that is received;
identifying a replacement data item of a same data type as the data item removed based upon one or more selection criteria comprising selection criteria based on the filtered data, the selection criteria also including at least one criterion for the replacement data item preselected by a user;
causing presentation of the filtered data in combination with the replacement data item, wherein the presentation is based at least partially upon the information regarding the data item that has been removed,
wherein the replacement data item comprises a data item previously received from a web-site or application other than a web-site or application causing presentation of the filtered data

47. A computer program product as claimed in claim 46, wherein the browsing activity is on the web-site or application causing presentation of the filtered data.

48. A computer program product as claimed in claim 46, wherein the web-site or application other than the web-site or application causing presentation of the filtered data comprises one of:
an electronic mail messaging web-site or application and the data item comprises an attachment to an electronic mail message;
an electronic mail messaging web-site or application the replacement data item comprises an attachment to an electronic mail message;
a multi-media messaging service web-site or application and the data item comprises an attachment to a multi-media messaging service message;
a multi-media messaging service web-site or application and the replacement data item comprises an attachment to a multi-media messaging service message;
a social network web-site or application and the data item comprises a data item provided by the social network web-site or application; and
a social network web-site or application and the replacement data item comprises a data item provided by the social network web-site or application.

49. A computer program product as claimed in claim 46, wherein the one or more selection criteria based upon the filtered data are pre-defined by a user's selection.

50. A computer program product as claimed in claim 46, wherein a type of replacement data item comprises at least one of an image, a video, an audio recording or an advertisement.
